(19) United States
(12) Patent Application Publication
(10) Pub. No.: US 2014/0242527 A1
(43) Pub. Date: Aug. 28, 2014

(54) REDUCED EMISSIONS COMBUSTOR

(71) Applicant: SAINT-GOBAIN CONTAINERS, INC., Muncie, IN (US)

(72) Inventors: David Galley, Paris (FR); Nicolas Enjalbert, Paris (FR); Thierry Barriant, Fishers, IN (US)

(21) Appl. No.: 14/349,574

(22) PCT Filed: Oct. 3, 2012
(86) PCT No.: PCT/US12/00432

§ 371 Date: Apr. 3, 2014

Related U.S. Application Data
(60) Provisional application No. 61/542,505, filed on Oct. 3, 2011.

(51) Int. Cl. C03B 5/235; F23C 5/08; F23L 7/00; F23D 14/22

(52) U.S. Cl. CPC C03B 5/2353; F23D 14/22; F23C 5/08; F23L 7/007
USPC 431/8; 431/181; 110/349

(57) ABSTRACT

Embodiments of this invention relate generally to furnaces, particularly to furnaces with combustors utilizing fuel and oxidizer jets, more particularly to furnaces used for glass production, and further to glass container production. In one embodiment, a furnace comprises first and second opposing walls, the first wall including a fuel nozzle having a fuel nozzle centerline extending toward the second wall, and an oxidizer nozzle having an oxidizer nozzle centerline extending toward the second wall and an oxidizer jet boundary. The first and second opposing walls are separated by a wall separation distance L. In this embodiment, the fuel nozzle centerline intersects the oxidizer jet boundary at a crossing distance x_{c}, whereby x_{c} is at least L/20 and at most L/2. In further embodiments, x_{c} is at least L/9 and at most L/6. In certain embodiments, the oxidizer jet centerline is inclined at an angle φ from a line perpendicular to the first wall, whereby the oxidizer jet boundary intersects with the fuel jet centerline at crossing distance x_{c} at a dilution ratio Δ, defined as Δ=0.119 (x_{c} I do) (cos 9.7°/cos (φ+9.7°)). In some embodiments, the dilution ratio Δ is greater than 2.5 and less than (4+(4+0.125*L²)/P^{0.5}), wherein L is measured in meters and P is the power contributed to the furnace by the burner measured in megawatts. In further embodiments, the dilution ratio Δ is less than (3+(1.3+0.042*L²)/P^{0.5}).

This application claims the benefit of U.S. Provisional Patent Application No. 61/542,505, entitled REDUCED EMISSIONS COMBUSTOR, filed Oct. 3, 2011 by David Galley, Nicolas Enjalbert, and Thierry Barriant, the entirety of which is hereby incorporated herein by reference.

### TECHNICAL FIELD

Embodiments of this invention relate generally to furnaces, particularly to furnaces with combustors utilizing fuel and oxidizer jets, more particularly to furnaces used for glass production, and further to glass container production. Particular embodiments relate to furnaces with gaseous fuel (for example, natural gas or propane) and gaseous oxidizer injected at high velocities to form turbulent jets in the furnace chamber.

### BACKGROUND

Furnaces burn combustible materials to produce heat. Large industrial furnaces, such as those used in the production of glass containers, frequently burn fuel (such as natural gas) in the presence of an oxidizer (such as oxygen) to generate heat. Undesirable byproducts, such as nitrogen oxides (“NOx”), can be formed and emitted by this process of heat generation. Environmental concerns and governmental regulations create incentives to limit the production of these undesirable emissions. Certain features of the present disclosure address these and other needs and provide other important advantages.

### SUMMARY

Embodiments of the present invention provide an improved reduced emissions combustor.

In accordance with one aspect of embodiments of the present invention, furnaces, such as those used in the process of the production of glass, or in particular of the manufacturing of glass containers, with combustors that produce low levels of nitrogen oxide (NOx) while maintaining a stable flame and minimizing, if not preventing, flame damage to the furnace walls are disclosed.

In one embodiment, a low NOx emission furnace is disclosed, the furnace comprising: first and second opposing walls; at least one fuel nozzle located within the first wall, the fuel nozzle having a fuel nozzle centerline extending toward the second wall; at least one oxidizer nozzle located within the first wall, the oxidizer nozzle having an oxidizer nozzle centerline extending toward the second wall, and around which an oxidizer jet with an oxidizer jet boundary will form; wherein the first and second opposing walls are separated by a wall separation distance L measured from the oxidizer nozzle to the second wall along the oxidizer nozzle centerline; wherein the fuel nozzle and the oxidizer nozzle are arranged such that the fuel nozzle centerline and the oxidizer jet boundary intersect at a distance equal to a crossing distance x_{c} measured from the oxidizer nozzle along the oxidizer nozzle centerline; and wherein x_{c} is at least L/20 and at most L/2. In another embodiment, x_{c} is at least L/15 and at most L/4. In a further embodiment, x_{c} is at least L/9 and at most L/6.

In another embodiment, the oxidizer jet dilution of the burner in the low NOx furnace is maintained within a specific dilution range. Dilution ratio Δ, as described below, is maintained such that Δ≧2.5 and Δ≦4+(4+0.125*L²)/P^{0.5}, where L is as defined above and expressed in meters, and P is as defined below (the power of the burner, in megawatts).

In a certain embodiment, a low NOx emission furnace, the furnace comprising: first and second opposing walls; at least one burner for injecting an oxidizer jet having an oxidizer jet boundary along an oxidizer nozzle centerline extending toward the second wall, and for injecting a fuel jet along a fuel nozzle centerline extending toward the second wall, the at least one burner located within the first wall; wherein the oxidizer jet boundary and the fuel nozzle centerline are arranged to intersect prior to reaching the second wall; wherein the first and second opposing walls are separated by a wall separation distance measured from the burner to the second wall along the oxidizer nozzle centerline; and wherein the dilution of the oxidizer jet at the intersection of the oxidizer jet and the fuel nozzle centerline is at most a value that varies based on the square of the wall separation distance.

In a further embodiment, a combustion process for burning a fuel is disclosed, the process comprising injecting at least one fuel jet and at least one oxidizer jet into a furnace, the oxidizer jet having a centerline and an oxidizer jet boundary and being injected from an oxidizer nozzle with a hydraulic diameter d_{O}; wherein the oxidizer jet boundary intersects with a centerline of the fuel jet at a crossing distance x_{c} at a dilution ratio Δ, defined as Δ=0.119 (x_{c}/d_{O}) (cos 9.7°/cos (φ+9.7°)), the dilution ratio Δ satisfying the following relationships: Δ≧2.5 and Δ≦4+(4+0.125*L²)/P^{0.5}, wherein L is the distance in meters across the furnace measured from the oxidizer nozzle along the oxidizer nozzle centerline and P is the power of the burner (defined below) measured in megawatts. In a certain embodiment, Δ≦3+(1.3+0.042*L²)/P^{0.5}.

Embodiments of the present invention provide an improved reduced emissions furnace for melting a glass batch and/or maintaining glass in molten form.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein is not necessarily intended to address every object described herein, and each embodiment does not necessarily include each feature described. Other forms, embodiments, objects, advantages, benefits, features, and aspects of the present invention will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions or may have been created from scaled drawings. However, such dimensions, or the relative scaling within a figure, are by way of example, and not to be construed as limiting.

FIG. 1 is a perspective view of a furnace according to one embodiment of the present invention.

FIG. 2 is a side elevational view of the furnace depicted in FIG. 1.

FIG. 3 is a top plan view of the furnace depicted in FIG. 1.

FIG. 4 is a fragmentary sectional view of a furnace according to another embodiment of the present invention.

FIG. 5 is a fragmentary view of the furnace depicted in FIG. 4.

FIG. 6 is a fragmentary view of the furnace depicted in FIG. 5 with the furnace wall not depicted for clarity.

FIG. 7 is an example orientation of the nozzles depicted in FIG. 6.

### DETAILED DESCRIPTION OF THE ILLUSTRATED EMBODIMENTS

For the purposes of promoting an understanding of the principles of the invention, reference will now be made to selected embodiments illustrated in the drawings and specific language will be used to describe the same. It will nevertheless be understood that no limitation of the scope of the invention is thereby intended; any alterations and further modifications of the described or illustrated embodiments, and any further applications of the principles of the invention as illustrated herein are contemplated as would normally occur to one skilled in the art to which the invention relates. At least one embodiment of the invention is shown in great detail, although it will be apparent to those skilled in the relevant art that some features or some combinations of features may not be shown for the sake of clarity.

Any reference to “invention” within this document herein is a reference to an embodiment of a family of inventions, with no single embodiment including features that are necessarily included in all embodiments, unless otherwise stated. Further, although there may be references to “advantages” provided by some embodiments of the present invention, it is understood that other embodiments may not include those same advantages, or may include different advantages. Any advantages described herein are not to be construed as limiting to any of the claims.

Specific quantities (spatial dimensions, pressures, momenta, dimensionless parameters, etc.) may be used explicitly or implicitly herein, such specific quantities are presented as examples and are approximate values unless otherwise indicated. Discussions pertaining to specific compositions of matter are presented as examples and do not limit the applicability of other compositions of matter, especially other compositions of matter with similar properties, unless otherwise indicated.

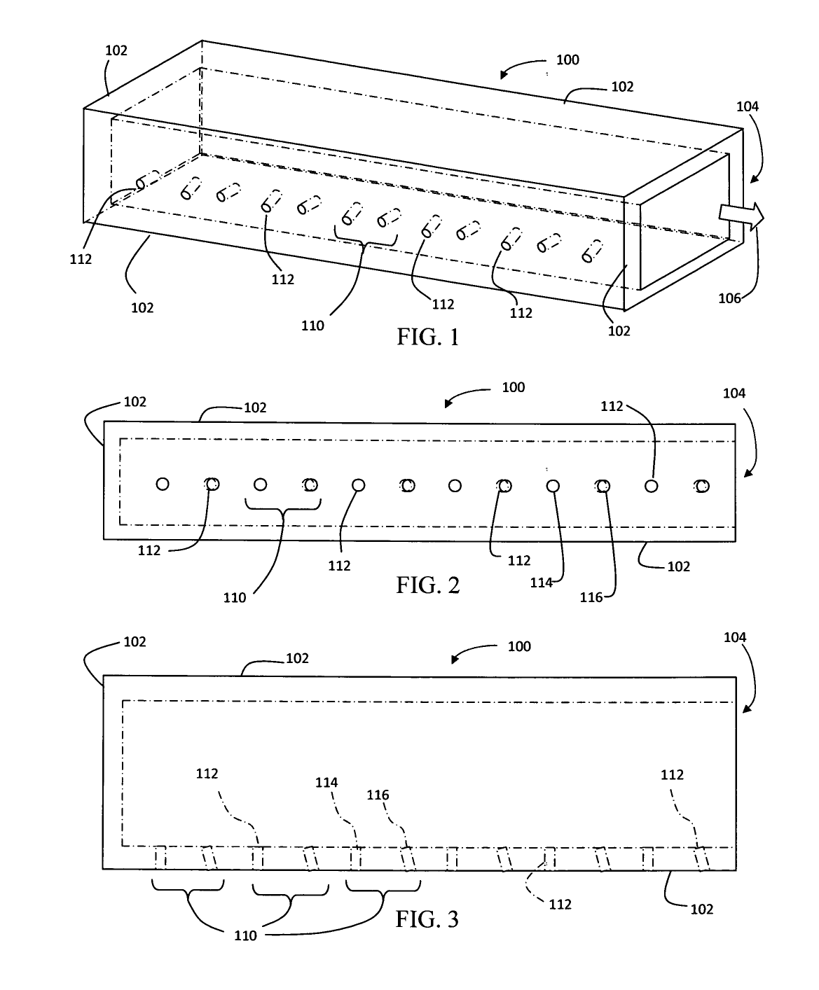

Depicted in FIGS. 1-3 is a schematic of a furnace 100 according to one embodiment of the present invention. Furnace 100 includes walls 102 that are typically insulated to contain the heat generated by the furnace in a localized area. Furnace 100 further includes an exit 104 through which the fumes produced by the furnace exit in direction 106. The wall opposite exit 104 is typically closed. Furnace 100 further includes burners 110, which include nozzles 112 that inject reactants (for example, a fuel and oxidizer) into furnace 100 to generate heat. Nozzles 112 are oriented at particular angles with respect to the furnace walls and with respect to one another to reduce emissions, for example, to reduce NOx emissions. In some embodiments, a burner 110 includes a nozzle 114 for injecting fuel and a nozzle 116 for injecting oxidizer. In one embodiment, the orientation of a burner's oxidizer nozzle 116 is no more than ten degrees) (10°) from perpendicular to the burner wall and the burner's fuel nozzle 114 is angled to have the centerline of the fuel intercept the oxidizer jet boundary at approximately one-seventh ( 1/7) the wall separation distance (as measured from the wall in which the burners 110 reside to the opposite wall along the centerline of the oxidizer nozzle). In another embodiment, the orientation of a burner's oxidizer nozzle 116 is no more than ten degrees (10°) from perpendicular to the burner wall and the burner's fuel nozzle 114 is angled to have the centerline of the fuel intercept the oxidizer jet boundary at approximately one-eighth (⅛) the wall separation distance.

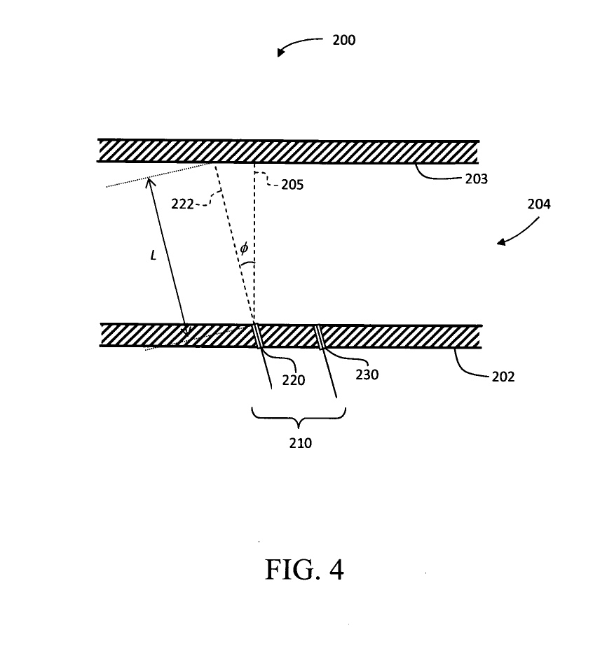

Depicted in FIGS. 4-7 are schematic views of a portion of a furnace 200 according to another embodiment of the present invention. Furnace 200 includes a burner wall 202 in which burner 210 is located. Only one burner 210 is depicted for clarity, although a plurality of burners 210 are present in many embodiments, and all burners 201 need not be located on the same burner wall 202. Furnace 200 also includes a facing wall 203 that is opposite burner wall 202. Furnace 200 further includes an exit 204.

Note that while at least some figures may indicate that burner wall 202 and facing wall 203 are parallel along substantially their entire lengths and compose a furnace that is substantially rectangular in cross-section, this is not limiting and alternate embodiments include furnaces which are substantially circular, elliptical, trapezoidal, or other non-rectangular shape in cross-section. In some embodiments, the burner wall 202 and facing wall 203 may be opposing portions of a contiguous wall. In other words, the depiction of burner wall 202 and facing wall 203 as parallel along substantially their entire lengths is by way of example and is not intended to limit the terms “opposite” or “opposing” to include only parallel walls.

Burner 210 can be any set of reactant injectors that provide oxidizer and fuel into furnace 200. Burner 210 is depicted as including an oxidizer injector (for example oxidizer nozzle 220) and a separate fuel injector (for example, fuel nozzle 230). However, burner 210 can take on different forms, such as a single-piece unit or other configurations, as would be understood by a person of ordinary skill in the relevant art. Burner 210 may optionally be referred to as a “diluted combustion burner” and is configured and adapted to reduce emissions (such as NOx) from furnace 200. In the glass manufacturing industry, the oxidizer (for example, oxygen) can be produced by an oxidizer generation device (for example, an oxygen generation facility) located near, and in some embodiments collocated with, the furnace site and directly connected to the oxidizer injectors of the furnace to provide a constant supply of oxidizer.

Referring in particular to FIG. 4, oxidizer nozzle 220 is angled such that the centerline 222 of the oxidizer jet emitted from the oxidizer nozzle 220 is inclined at an angle φ from a line 205 perpendicular to burner wall 202. The distance from oxidizer nozzle 220 to facing wall 203 along the centerline 222 of oxidizer nozzle 220 is denoted by L and referred to as the wall separation distance. If the burner wall 202 and facing wall 203 are parallel and their orthogonal distance is l, then L=l/cos φ. The wall separation distance can easily be calculated in other wall configurations. In industrial scale furnaces, such as those used in the production of glass, in particular of container glass, L is typically at least 3 meters and at most 12 meters.

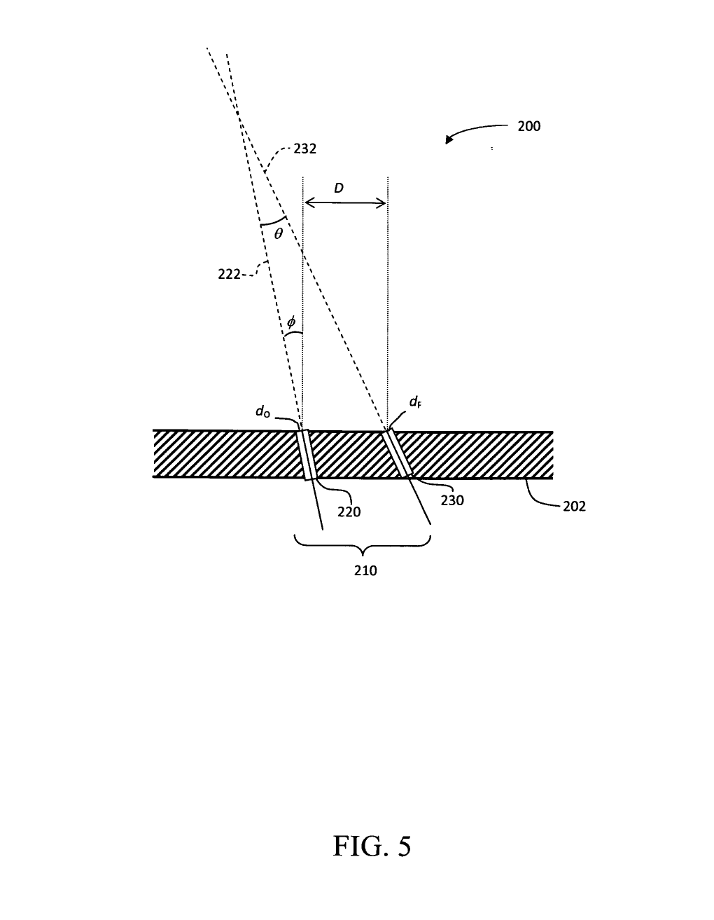

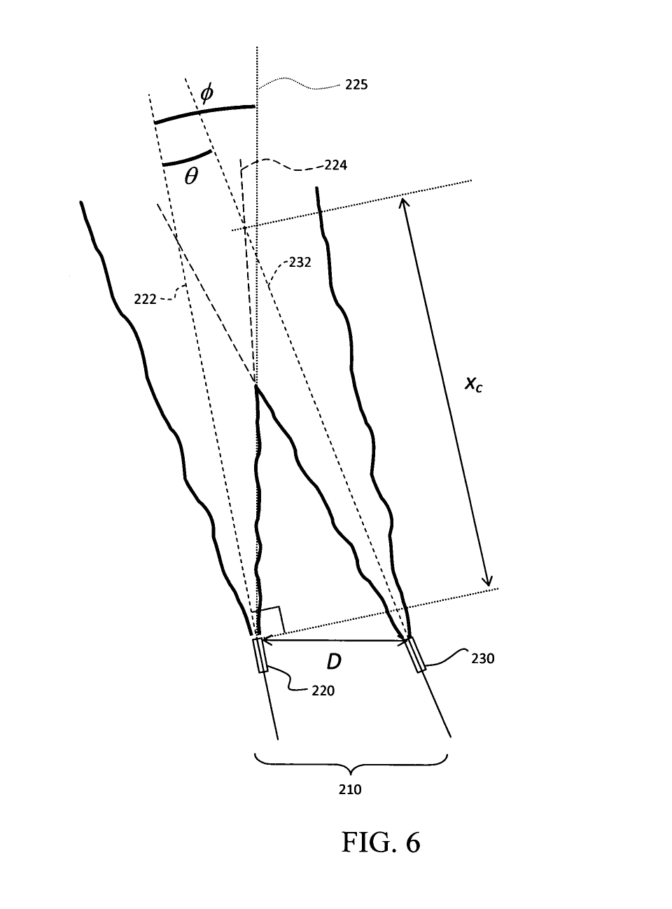

Referring in particular to FIGS. 5 and 6, the inter-nozzle distance between oxidizer nozzle 220 and fuel nozzle 230 is distance D. The crossing angle between the oxidizer jet centerline 222 and the orthogonal projection of the fuel jet centerline 232 on the plane formed by the fuel nozzle 230 and the oxidizer jet centerline 222 is denoted as θ. The hydraulic diameter of oxidizer nozzle 220 is denoted as d_{O} and the hydraulic diameter of the fuel nozzle 230 is denoted as d_{F}. It should be appreciated that the cross-sectional area of the nozzles is not necessarily circular, with the hydraulic diameter of a nozzle being the diameter of a circular disk having the same cross-sectional area as the nozzle.

In certain embodiment, the inter-nozzle distance D is at least L/50 and at most L/10, while in alternate embodiment the inter-nozzle distance D is approximately L25. In still further embodiment, the inter-nozzle distance D is approximately ⅓ meters, while in other embodiments the inter-nozzle distance D is 330 mm.

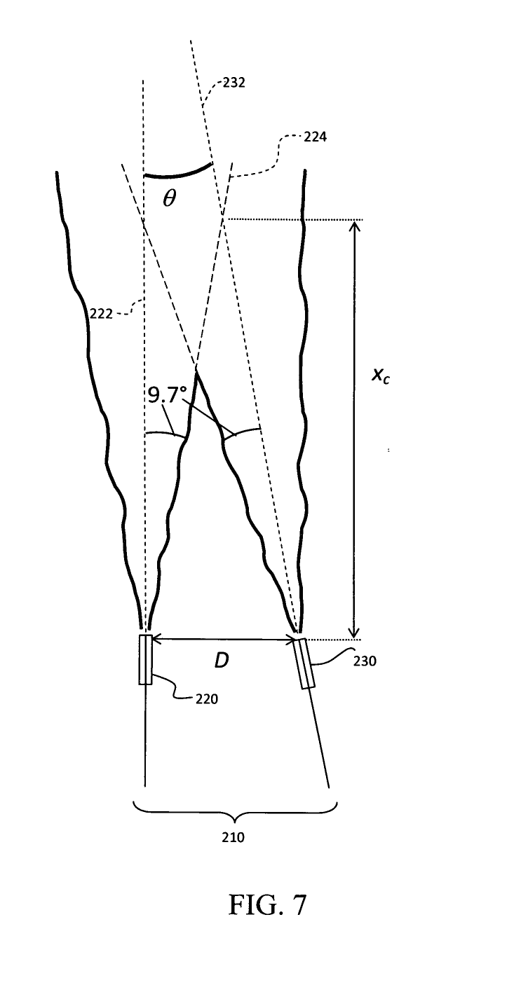

The crossing distance x_{c}, as shown in FIGS. 6 and 7, is the distance from the oxidizer nozzle 220 at which the fuel nozzle centerline 232 intercepts the oxidizer jet boundary 224 as measured along the oxidizer nozzle centerline 222. Stated another way, the crossing distance x_{c} is the distance from the oxidizer nozzle 220, as measured along the oxidizer nozzle centerline 222, at which a line passing through the intersection of the oxidizer jet boundary 224 and fuel nozzle centerline 232 would pass through the oxidizer nozzle centerline 222 perpendicularly.

The oxidizer jet boundary 224 for an oxidizer nozzle 220 may be approximated as a cone of azimuthal opening 9.7° extending from the oxidizer nozzle 220 in the direction of the oxidizer nozzle centerline 222 (see, for example, FIG. 7). In the case of approximately coplanar injection directions, the expression for the crossing distance is:

x_{c}=D/(tan (9.7°+φ))+tan (θ−φ)).

It should be understood that, in the above equation and other equations below, the “9.7°” term can be replaced with the actual azimuthal opening angle when a nozzle with different opening characteristics is used.

It was discovered that by controlling the angles of the oxidizer nozzle 220 and the fuel nozzle 230, and the crossing distance x_{c}, emissions (such as NOx) could be decreased while minimizing, if not eliminating, flame induced damage to facing wall 203. In some embodiments, the crossing distance x_{c} is equal to at least L/20 and at most L2. In other embodiments, the crossing distance x_{c} is equal to at least L/15 and at most L/4. In further embodiments, the crossing distance x_{c} is equal to at least L/9 and at most L/6, and in still further embodiments the crossing distance x_{c} equals approximately L/8. In certain embodiments, the crossing distance x_{c} equals approximately L/7, while in still further embodiments, x_{c} equals L/6.9.

It was also discovered that the angle φ can affect the amount of undesirable emissions and the amount of damage (or absence of damage) to facing wall 203. In general, the oxidizer injection angle φ (the angle between the oxidizer jet centerline 222 and a line 225 that is orthogonal to wall from which the oxidizer jet emanates) can be from 0 degrees to 80 degrees. In some embodiments, the oxidizer injection angle φ is at least 46 degrees and at most 80 degrees. In other embodiments the oxidizer injection angle φ is at least 11 degrees and at most 45 degrees. In still further embodiments the oxidizer injection angle φ is at least 1 degree and at most 10 degrees.

Another parameter that was also discovered to affect the amount of undesirable emissions and the level of damage to facing wall 203 was the crossing angle θ. In general, the crossing angle θ can be from 0 degrees to 80 degrees. In some embodiments, the crossing angle θ is at least 0 degrees and at most 25 degrees. In still further embodiments, the crossing angle θ is at least 5 degrees and at most 15 degrees, while in still other embodiments the crossing angle θ is approximately 10 degrees.

Note that while at least some figures may indicate that nozzles are pointed perpendicular to or away from exit 104 or exit 204, this is not limiting and alternate embodiments include nozzles pointed toward exit 104 or exit 204. In other words, the depiction of exit 104/204 as being on the right-hand side of FIGS. 1-4 is by way of example and some embodiment furnaces have exits on the left-hand side, but are otherwise as depicted in FIGS. 1-4.

The injection of a fluid (such as a gaseous reactant) into a fluid environment (such as a furnace chamber mostly filled with burnt gases) produces, at sufficient velocities to generate turbulence (which is frequently the case with industrial-scale furnaces), a so-called turbulent jet. Once sufficiently far away from the nozzle (for example, about twenty times the hydraulic diameter along the jet centerline) turbulent jets are typically conical in shape, and typically have an opening angle of about 10°, 9.7° according to many sources. At injection velocities high enough, they develop into a cylindrically-symmetric shape with a centerline that is (approximately) aligned with the nozzle axis.

The time-averaged velocity amplitudes of a turbulent jet generally decrease as the inverse of the distance from the nozzle. This is also the case for the time-averaged concentration of an injected fluid (for example, fuel). Generally, the widening of the jet, decrease in velocity, and decrease in concentration are due, at least in part, to turbulent entrainment. Surrounding gases are entrained by turbulent structures that develop at the boundary between the turbulent jet and its environment. The furnace chamber is typically filled with combustion products (such as carbon dioxide CO2, water vapor H2O), which are non-reacting gases that result from the reaction of the fuel and the oxidizer. Typically, these combustion products do not react with the oxygen contained in the oxidizer.

As such, the injected fluid concentration, initially approaching (if not equal to) 100% immediately downstream of the nozzle, decreases due to the increasing quantity of surrounding combustion products that dilute the flow along the course of the turbulent jet. Reactants, such as fuel and oxidizer that are initially injected in high concentration, are diluted by turbulent entrainment within their respective jets. Under certain conditions as described herein (such as by controlling fuel and oxidizer injection geometry), a reaction zone can be formed with relatively low concentrations of fuel and oxidizer, enabling decreased flame temperatures, an extended and more homogeneous reaction zone, and lowered emissions (such as NOx).

In general, the concentration of oxygen (O₂) in the injected oxidizer fluid is typically at least 20% and at most 100%. In certain embodiments, the concentration of O₂ in the oxidizer fluid is at least 85%.

Generally speaking, the dilution ratio Δ in a turbulent jet is the ratio of the mass flow rate of furnace gases entrained into the jet to the mass flow rate of gas initially injected through the jet nozzle, assessed at a given distance from the jet nozzle along its centerline. The higher the dilution ratio, the more the jet is diluted with the surrounding furnace gases. A dilution of Δ=n indicates that the jet has entrained n times its initial mass. In other words, the jet has been diluted n times (in mass) with surrounding furnace gases. The amount of emissions (such as NOx) depend, at least in part, on the dilution ratio that is found in the combustion zone (sometimes referred to as the reaction zone). In general, higher dilutions result in lower peak flame temperatures. In the case of one turbulent oxidizer jet and one turbulent fuel jet meeting within the furnace chamber, the amount of emissions (such as NOx) can be related to the dilution ratio of the oxidizer jet measured at the point where the fuel jet centerline crosses the boundary of the oxidizer jet. In other words, emissions can be related to the oxidizer jet dilution ratio assessed at a distance from the oxidizer nozzle 220, along the oxidizer nozzle centerline 222, which is equal to the crossing distance x_{c}. At this position, dilution of the oxidizer jet may be determined by the following expression:

Δ=0.119 (x_{c}/d_{O}) (cos 9.7°/cos (φ+9.7°)).

It was discovered that dilution should be maintained within a certain range to reduce the level of emissions (such as NOx emissions) and to ensure flame stability. Dilution that is too low tends to result in larger amounts of undesirable emissions and unstable flames, especially in situations where the inter-nozzle distance is fixed. However, dilution that is too high can cause damage to facing wall 203 from heat transfer. For a given arrangement of fuel and oxidizer nozzles (angles, inter-nozzle distance, etc.) in a furnace, the heat transfer to the facing wall 203 tends to increase with increasing injection velocity. Heat transfer to the facing wall 203 tends to increase as the nozzle diameter decreases, especially in situations where burner power is fixed. Heat transfer to the facing wall 203 also tends to increase as the burner power increases, especially at fixed nozzle diameters. In one sense, a minimum dilution criterion can be thought of as a minimum velocity that, for a given burner power, can be achieved by setting maximum injection diameters. Conversely, a maximum dilution criterion can be thought of as restricting the flame momentum to avoid damaging facing wall 203 by excessive heat transfer.

Burner power is frequently calculated as the product of either the fuel volume flow rate injected through the fuel nozzle by the fuel's lower heating value (expressed in megawatt-hours per unit volume) or the fuel mass flow rate through the fuel nozzle by the fuel's lower heating value (expressed in megawatt-hours per unit mass). It is common to inject the oxidizer at a rate large enough to fully combust the fuel, that is, large enough for no significant amount of unburnt fuel to remain downstream of the reaction zone, which is frequently referred to as complete combustion. In industrial scale furnaces, such as those used in the production of glass, in particular of container glass, the power of one burner is typically at least 0.5 megawatts and at most 6 megawatts.

It was discovered that limiting the dilution of burner 210 in some embodiments to a minimum value of 2.5 (in other words, Δ≧2.5) is sufficient to reduce emissions (such as NOx emissions) and ensure flame stability. In alternate embodiments, minimum dilution value is limited to 2.2 (in other words, Δ≧2.2). Moreover, while limiting the dilution of burner 210 to a minimum value of 2.2 resulted in reduced emissions, the level of emissions reduction at Δ=2.2 was not as significant as at Δ=2.5, indicating a possible minimum dilution value of approximately 2.0, below which reductions in dilution may not result in reduced emissions.

Limiting the dilution of burner 210 to a maximum value, denoted as Δₘₐₓ, that depends on the furnace geometry achieved the goal of limiting, if not eliminating, flame damage to facing wall 203. It was discovered that Δₘₐₓ varies as a function of the square of the wall separation distance and the square root of the furnace power. In certain embodiments, the dilution is therefore imposed the restriction:

Δ≦Δₘₐₓ

where the maximum dilution is expressed as:

Δₘₐₓ=4+(4+0.125*L²)/P^{0.5}

where L is the wall separation distance (the distance in meters from the oxidizer nozzle to the facing wall along the centerline of the oxidizer nozzle), and P is the power of the burner, in megawatts. In further embodiments, the maximum dilution is limited to:

Δₘₐₓ=3+(1.3+0.042*L²)/P^{0.5}

It is noted that the above relationships for Δₘₐₓ are not correctly dimensional expressions. In other words, the units of the left-hand-side of each expression (which are dimensionless) do not match the units of the right-hand-side of the expression (which are meters squared divided by the square root of megawatts), but this relationship was discovered to correctly represent a maximum dilution value.

The ratio of fuel injection velocity to oxidizer injection velocity can also affect both flame stability and dilution. By maintaining this velocity ratio within a particular range, appropriate dilution and flame stability could be realized. In one embodiment, the ratio of fuel injection velocity to oxidizer injection velocity is at least 0.15 and at most 6, while in another embodiment this ratio is at least 0.5 and at most 2. In still other embodiments, the ratio of the fuel injection velocity to the oxidizer injection velocity is at least 0.8 and at most 1.2.

Although the diameter of the fuel nozzle d_{F} affects dilution of the fuel jet, it was discovered that controlling the ratio of fuel injection velocity to oxidizer injection velocity appears to have a more direct impact on the production of emissions (such as NOx) than controlling d_{F} alone.

Various embodiments of the present invention include different combinations of the disclosed ranges of the above parameters, for example, x_{c}, φ, θ, Δ, and the ratio of fuel injection velocity to oxidizer injection velocity. For example, in one embodiment L/20≦x_{c}≦L/2, 0°≦φ≦25°, and 5°≦θ≦15°, with other embodiments optionally including Δ≦4+(4+0.125*L²)/P^{0.5}, and the ratio of fuel injection velocity to oxidizer injection velocity optionally being at least 0.15 and at most 6. In still another example embodiment, x_{c}=approximately L/8, 0°≦φ≦10°, θ=approximately 10°, Δ≦3+(1.3+0.042*L²)/P^{0.5}, and the ratio of fuel injection velocity to oxidizer injection velocity is at least 0.8 and at most 1.2.

In some embodiments, the interior of the furnace 100, 200 is maintained at a pressure slightly above ambient atmospheric pressure to minimize outside air from entering the furnace 100, 200 via the exit 104, 204. In certain embodiments, the interior of the furnace 100, 200 is maintained at about 4 Pascals or about 7.5 Pascals above atmospheric pressure. While increased pressure within the furnace appears to decrease emissions (such as NOx), this effect of pressure on emissions appears to be somewhat less than the effect of dilution on emissions.

When the combustion burner geometry is controlled as outlined above, a significant reduction of undesirable emissions (such as NOx) can be realized while maintaining flame stability and minimizing (if not eliminating) damage to the opposite furnace wall caused by the burners.

Various aspects of different embodiments of the present disclosure are expressed in paragraphs X1, X2, X3 and X4 as follows:

X1. One embodiment of the present disclosure includes a furnace, comprising: first and second opposing walls; the first wall including a fuel nozzle, the fuel nozzle having a fuel nozzle centerline extending toward the second wall; the first wall including an oxidizer nozzle, the oxidizer nozzle having an oxidizer nozzle centerline extending toward the second wall, wherein oxidizer flowing through the oxidizer nozzle forms an oxidizer jet defining an oxidizer jet boundary; wherein the first and second opposing walls are separated by a wall separation distance L measured from the oxidizer nozzle to the second wall along the oxidizer nozzle centerline; wherein the fuel nozzle centerline intersects the oxidizer jet boundary at a crossing distance measured from the oxidizer nozzle along the oxidizer nozzle centerline; and wherein x_{c} is at least L/20 and at most L/2.

X2. Another embodiment of the present disclosure includes a method of operating a furnace comprising: generating at least one fuel jet at a first wall of a furnace; generating at least one oxidizer jet at the first wall of the furnace, the oxidizer jet having a centerline and an oxidizer jet boundary, the furnace including a second wall separated from the first wall by a wall separation distance L measured from the location on the first wall where the oxidizer jet is generated to the second wall along the oxidizer jet centerline; and mixing the oxidizer jet and the fuel jet, wherein said mixing includes crossing the oxidizer and fuel jets with the oxidizer jet boundary intersecting the centerline of the fuel jet at a crossing distance x_{c}, measured from the oxidizer nozzle along the oxidizer jet centerline, wherein x_{c} is at least L/20 and at most L/2.

X3. A further embodiment of the present disclosure includes a method, comprising: injecting at least one fuel jet and at least one oxidizer jet into a furnace, the oxidizer jet having a centerline and an oxidizer jet boundary and being injected from an oxidizer nozzle with a hydraulic diameter d_{O}; wherein the oxidizer jet centerline is inclined at an angle φ from a line perpendicular to a first wall of the furnace; wherein the oxidizer jet boundary intersects with a centerline of the fuel jet at a crossing distance x_{c}; and maintaining a dilution ratio Δ, defined as Δ=0.119 (x_{c}/d_{O}) (cos 9.7°/cos (φ+9.7°), between 2.5 and 4+(4+0.125*L²)/P^{0.5}, wherein L is the distance across the furnace in meters measured from the oxidizer nozzle along the oxidizer nozzle centerline and P is the power contributed to the furnace by the complete combustion of the fuel injected through the fuel nozzle.

X4. A yet further embodiment of the present disclosure includes a furnace, comprising: first and second opposing walls; the first wall including a fuel nozzle, the fuel nozzle having a fuel nozzle centerline extending toward the second wall; the first wall including an oxidizer nozzle, the oxidizer nozzle having an oxidizer nozzle centerline extending toward the second wall and an oxidizer jet boundary, the oxidizer nozzle defining hydraulic diameter d_{O}; wherein the first and second opposing walls are separated by a wall separation distance L measured from the oxidizer nozzle to the second wall along the oxidizer nozzle centerline; wherein the oxidizer nozzle centerline is inclined at an angle θ from a line perpendicular to the first wall; wherein the oxidizer jet boundary intersects with a centerline of the fuel jet at a crossing distance x_{c}, measured from the oxidizer nozzle along the oxidizer nozzle centerline; and means for maintaining the dilution ratio Δ between 2.5 and 4+(4+0.125*L²)/P^{0.5}, wherein L is measured in meters, P is the power of the furnace measured in megawatts, and the dilution ratio Δ is defined as Δ=0.119 (x_{c}/d_{O}) (cos 9.7°/cos (φ+9.7°)).

Yet other embodiments include the features described in any of the previous statements X1, X2 X3 or X4, as combined with one or more of the following aspects:

Wherein x_{c} is at least L/15 and at most L/4.

Wherein x_{c} is at least L/9 and at most L/6.

Wherein x_{c} is approximately L/7.

Wherein x_{c} is approximately L/8.

Wherein L is at least 3 meters and at most 12 meters.

Wherein the fuel nozzle and the oxidizer nozzle are spaced apart by an inter-nozzle distance of approximately ⅓ meters.

Wherein the fuel nozzle and the oxidizer nozzle are spaced apart by an inter-nozzle distance of at least L/50 and at most L/10.

Wherein the fuel nozzle and the oxidizer nozzle are spaced apart by an inter-nozzle distance of approximately L25.

Wherein the oxidizer nozzle centerline and the fuel nozzle centerline intersect at a crossing angle θ, and wherein the crossing angle θ is at least 0 degrees and at most 80 degrees.

Wherein the oxidizer nozzle centerline and the fuel nozzle centerline intersect at a crossing angle θ, and wherein the crossing angle θ is at least 5 degrees and at most 15 degrees.

Wherein the oxidizer nozzle centerline and the fuel nozzle centerline intersect at a crossing angle θ, and wherein the crossing angle θ is approximately 10 degrees.

Wherein the oxidizer nozzle centerline is inclined at an angle φ from a line perpendicular to the first wall, and wherein the angle φ is at least 11 degrees and at most 45 degrees.

Wherein the oxidizer nozzle centerline is inclined at an angle φ from a line perpendicular to the first wall, and wherein the angle φ is at least 1 degree and at most 10 degrees.

Wherein the oxidizer nozzle includes a hydraulic diameter d_{O}, and wherein the oxidizer nozzle centerline is inclined at an angle φ from a line perpendicular to the first wall, and wherein the oxidizer jet boundary intersects the fuel nozzle centerline at the crossing distance x_{c} at a dilution ratio Δ, defined as Δ=0.119 (x_{c}/d_{O}) (cos 9.7°/cos (φ+9.7°)), the dilution ratio Δ being maintained within and/or satisfying the following relationship: 2.2≦Δ≦4+(4+0.125*L²)/P^{0.5},

wherein P is the power contributed to the furnace by the complete combustion of the fuel injected through the fuel nozzle, expressed in megawatts, and L is measured in meters.

Wherein the dilution ratio Δ is maintained within and/or satisfies the following relationship: 2.5≦Δ≦3+(1.3+0.042*L²)/P^{0.5}.

Wherein the dilution ratio Δ is at most 3+(1.3+0.042*L²)/P^{0.5}.

Wherein the dilution ratio Δ is at most 4+(4+0.125*L²)/P^{0.5}.

Wherein the dilution ratio Δ is at least 2.5.

Wherein the dilution ratio Δ is at least 2.2.

Wherein the dilution ratio Δ is at least 2.0.

Wherein the ratio between the fuel injection velocity and the oxidizer injection velocity is at least 0.15 and at most 6.

Wherein the ratio between the fuel injection velocity and the oxidizer injection velocity is at least 0.5 and at most 2.

Wherein the ratio between the fuel injection velocity and the oxidizer injection velocity is at least 0.8 and at most 1.2.

A plurality of fuel nozzle and oxidizer nozzle pairs arranged as described in one or more of the above paragraphs.

A plurality of fuel and oxidizer nozzles as described in one or more of the above paragraphs, the plurality of fuel and oxidizer nozzles being arranged in pairs, each pair defining a burner including a fuel nozzle and an oxidizer positioned adjacent one another with no fuel or oxidizer nozzle positioned therebetween.

Wherein the plurality of burners includes at least 2 and at most 40 burners.

Wherein the plurality of burners includes at least 4 and at most 15 burners.

An oxidizer generation device connected to the oxidizer nozzle.

An oxidizer generation device that delivers oxidizer of at least 20% oxygen (O₂) to the oxidizer nozzle.

An oxidizer generation device that delivers oxidizer of at least 80% oxygen (O₂) to the oxidizer nozzle.

Wherein fuel flows through the fuel nozzle and oxidizer flows through the oxidizer nozzle.

Wherein the oxidizer flowing through the oxidizer nozzle is at least 20% oxygen (O₂).

Wherein the oxidizer flowing through the oxidizer nozzle is at least 80% oxygen (O₂).

A glass batch located between first and second opposing walls, wherein the fuel is combusted to generate heat, wherein the glass batch absorbs heat from the fuel, and/or wherein the glass batch is at least partially molten.

Melting a glass batch.

Maintaining glass in a molten form.

Wherein the fuel injection velocity is at least 0.8 and at most 1.2 times the oxidizer velocity, and wherein the oxidizer nozzle centerline is inclined at an angle φ from a line perpendicular to the first wall, and wherein the angle φ is at least 0 degrees and at most 10 degrees.

Means for maintaining the dilution ratio Δ between 2.5 and 4+(4+0.125*L²)/P^{0.5}, wherein L is measured in meters, P is the power of the furnace measured in megawatts, and the dilution ratio Δ is defined as Δ=0.119 (x_{c}/d_{O}) (cos 9.7°/cos (φ+9.7°)).

Means for maintaining the dilution ratio Δ between 2.5 and 3+(1.3+0.042*L²)/P^{0.5}.

Means for maintaining the dilution ratio Δ to at most 3+(1.3+0.042*L²)/P^{0.5}.

Means for maintaining the dilution ratio Δ to at most 4+(4+0.125*L²)/P^{0.5}.

Means for maintaining the dilution ratio Δ to at least 2.5.

Means for maintaining the dilution ratio Δ to at least 2.2.

Means for maintaining the dilution ratio Δ to at least 2.0.

Reference systems, if used herein, refer generally to various directions (for example, upper, lower, forward, rearward, left, right, etc.), which are merely offered to assist the reader in understanding the various embodiments of the disclosure and are not to be interpreted as limiting. Other reference systems may be used to describe various embodiments.

While illustrated examples, representative embodiments and specific forms of the invention have been illustrated and described in detail in the drawings and foregoing description, the same is to be considered as illustrative and not restrictive or limiting. The description of particular features in one embodiment does not imply that those particular features are necessarily limited to that one embodiment. Features of one embodiment may be used in combination with features of other embodiments as would be understood by one of ordinary skill in the art, whether or not explicitly described as such. Exemplary embodiments have been shown and described, and all changes and modifications that come within the spirit of the invention are desired to be protected.

1. A furnace, comprising:
first and second opposing walls;
said first wall including a fuel nozzle, said fuel nozzle having a fuel nozzle centerline extending toward said second wall;
said first wall including an oxidizer nozzle, said oxidizer nozzle having an oxidizer nozzle centerline extending toward said second wall, wherein oxidizer flowing through said oxidizer nozzle forms an oxidizer jet defining an oxidizer jet boundary;
wherein said first and second opposing walls are separated by a wall separation distance L measured from said oxidizer nozzle to said second wall along said oxidizer nozzle centerline;
wherein said fuel nozzle centerline intersects said oxidizer jet boundary at a crossing distance x_{c} measured from said oxidizer nozzle along said oxidizer nozzle centerline; and
wherein x_{c} is at least L/20 and at most L/2.

2. (canceled)

3. The furnace of claim 1, wherein x_{c} is at least L/9 and at most L/6.

4-5. (canceled)

6. The furnace of claim 1, wherein L is at least 3 meters and at most 12 meters.

7. The furnace of claim 1, wherein said fuel nozzle and said oxidizer nozzle are spaced apart by an inter-nozzle distance of approximately ⅓ meters.

8. (canceled)

9. The furnace of claim 1, wherein said fuel nozzle and said oxidizer nozzle are spaced apart by an inter-nozzle distance of approximately L/25.

10. (canceled)

11. The furnace of claim 1, wherein said oxidizer nozzle centerline and said fuel nozzle centerline intersect at a crossing angle θ, and wherein said crossing angle θ is at least 5 degrees and at most 15 degrees.

12-13. (canceled)

14. The furnace of claim 1, wherein said oxidizer nozzle centerline is inclined at an angle φ from a line perpendicular to said first wall, and wherein said angle φ is at least 1 degree and at most 10 degrees.

15. The furnace of claim 1, wherein said oxidizer nozzle includes a hydraulic diameter d_{O}, and wherein said oxidizer nozzle centerline is inclined at an angle φ from a line perpendicular to said first wall, and wherein said oxidizer jet boundary intersects said fuel nozzle centerline at said crossing distance x_{c} at a dilution ratio Δ, defined as Δ=0.119 (x_{c}/d_{O}) (cos 9.7°/cos (φ+9.7°)), said dilution ratio Δ satisfying the following relationships:
2.2≦Δ≦4+(4+0.125*L²)/P^{0.5}
wherein P is the power contributed to the furnace by the complete combustion of fuel injected through said fuel nozzle, expressed in megawatts, and L is measured in meters.

16. The furnace of claim 15, wherein
2.5≦Δ≦3+(1.3+0.042*L²)/P^{0.5}

17-18. (canceled)

19. The furnace of claim 1, comprising an oxidizer injection velocity and a fuel injection velocity, wherein said fuel injection velocity is at least 0.8 and at most 1.2 times said oxidizer injection velocity.

20. (canceled)

21. The furnace of claim 1, further comprising a plurality of fuel and oxidizer nozzles as described in claim 1, the plurality of fuel and oxidizer nozzles being arranged in pairs, each pair defining a burner including a fuel nozzle and an oxidizer positioned adjacent one another with no fuel or oxidizer nozzle positioned therebetween.

22-23. (canceled)

24. The furnace of claim 1, further comprising an oxidizer generation device connected to said oxidizer nozzle.

25-26. (canceled)

27. The furnace of claim 24, comprising a glass batch located between said first and second opposing walls, said fuel being combusted to generate heat, said glass batch absorbing heat from said fuel and said glass batch being at least partially molten.

28. The furnace of claim 1,
wherein x_{c} is at least L/15 and at most L/4;
wherein said oxidizer nozzle centerline and said fuel nozzle centerline intersect at a crossing angle θ, said crossing angle θ being at least 5 degrees and at most 15 degrees; and
wherein said oxidizer nozzle includes an exit orifice through which oxidizer is injected into the furnace, said exit orifice having a hydraulic diameter d_{O},
wherein said oxidizer nozzle centerline is inclined at an angle φ from a line perpendicular to said first wall, and
wherein said oxidizer jet boundary intersects said fuel nozzle centerline at said crossing distance x_{c} at a dilution ratio Δ, defined as Δ=0.119 (x_{c}/d_{O}) (cos 9.7°/cos (φ+9.7°)), said dilution ratio Δ satisfying the following relationships:
2.2≦Δ≦4+(4+0.125*L²)/P^{0.5}
wherein P is the power contributed to the furnace by the complete combustion of fuel injected through said fuel nozzle, expressed in megawatts, and L is measured in meters.

29. (canceled)

30. The furnace of claim 28, comprising an oxidizer injection velocity and a fuel injection velocity, wherein the fuel injection velocity is at least 0.8 and at most 1.2 times the oxidizer velocity, and wherein said oxidizer nozzle centerline is inclined at an angle φ from a line perpendicular to said first wall, and wherein said angle φ is at least 0 degrees and at most 10 degrees.

31. (canceled)

32. The furnace of claim 28, comprising fuel flowing through the fuel nozzle and oxidizer flowing through the oxidizer nozzle and wherein said oxidizer is at least 80% oxygen (O₂).

33-35. (canceled)

36. The furnace of claim 28, wherein L is at least 3 meters and at most 12 meters.

37. A method of operating a furnace comprising:
generating at least one fuel jet at a first wall of a furnace;
generating at least one oxidizer jet at the first wall of the furnace, the oxidizer jet having a centerline and an oxidizer jet boundary, the furnace including a second wall separated from the first wall by a wall separation distance L measured from the location on the first wall where the oxidizer jet is generated to said second wall along said oxidizer jet centerline;
mixing the oxidizer jet and the fuel jet, wherein said mixing includes crossing the oxidizer and fuel jets with the oxidizer jet boundary intersecting the centerline of the fuel jet at a crossing distance x_{c}, measured from said oxidizer nozzle along said oxidizer jet centerline, wherein x_{c} is at least L/20 and at most L/2; and
combusting said fuel jet.

38. (canceled)

39. The method of claim 37, wherein the crossing distance x_{c} is at least L/9 and at most L/6.

40. The method of claim 37, wherein the crossing distance x_{c} is approximately L/7.

41. The method of claim 37, wherein said mixing includes crossing the oxidizer jet centerline and the fuel jet centerline at a crossing angle θ equal to approximately 10 degrees.

42. The method of claim 37, comprising:
maintaining a dilution ratio Δ of at least 2.2 and at most 4+(4+0.125*L²)/P^{0.5}, wherein
the dilution ratio Δ is defined as Δ=0.119 (x_{c}/d_{O}) (cos 9.7°/cos (φ+9.7°)),
d_{O} is the hydraulic diameter of the oxidizer nozzle generating the oxidizer jet,
φ is the angle at which the oxidizer jet centerline is inclined with respect to a line perpendicular to the first wall, and
wherein P is the power contributed to the furnace by the complete combustion of the fuel injected through said fuel nozzle, expressed in megawatts, and L is measured in meters.

43. The method of claim 42, wherein said maintaining includes maintaining a dilution ratio Δ of at least 2.5 and at most 3+(1.3+0.042*L²)/P^{0.5}.

44. (canceled)

45. The method of claim 43, wherein L is at least 3 meters and at most 12 meters.

46. (canceled)

47. The method of claim 37, wherein said injecting results in a ratio between said fuel injection velocity and said oxidizer injection velocity of at least 0.8 and at most 1.2.

48. The method of claim 37, wherein said generating at least one fuel jet includes generating at least one turbulent fuel jet, and wherein said generating at least one oxidizer jet includes generating at least one turbulent oxidizer jet.

49. (canceled)

50. A method, comprising:
injecting at least one fuel jet and at least one oxidizer jet into a furnace, said oxidizer jet having a centerline and an oxidizer jet boundary and being injected from an oxidizer nozzle with a hydraulic diameter d_{O};
wherein said oxidizer jet centerline is inclined at an angle φ from a line perpendicular to a first wall of said furnace;
wherein said oxidizer jet boundary intersects with a centerline of said fuel jet at a crossing distance x_{c};
combusting said fuel jet; and
maintaining a dilution ratio Δ, defined as Δ=0.119 (x_{c}/d_{O}) (cos 9.7°/cos (φ+9.7°)), between 2.5 and 4+(4+0.125*L²)/P^{0.5}, wherein L is the distance across said furnace in meters measured from said oxidizer nozzle along said oxidizer nozzle centerline and P is the power contributed to the furnace by the complete combustion of the fuel injected through said fuel nozzle.

51. The method of claim 50, wherein Δ≦3+(1.3+0.042*L²)/P^{0.5}.

52. The method of claim 51, wherein L is at least 3 meters and at most 12 meters.

53. (canceled)

54. The method of claim 50, wherein x_{c} is greater than L/15 and less than L/4.

55. The method of claim 50, wherein x_{c} is greater than L/9 and less than L/6.

56. A furnace, comprising:
first and second opposing walls;
said first wall including a fuel nozzle, said fuel nozzle having a fuel nozzle centerline extending toward said second wall;
said first wall including an oxidizer nozzle, said oxidizer nozzle having an oxidizer nozzle centerline extending toward said second wall and an oxidizer jet boundary, said oxidizer nozzle defining hydraulic diameter d_{O};
wherein said first and second opposing walls are separated by a wall separation distance L measured from said oxidizer nozzle to said second wall along said oxidizer nozzle centerline;
wherein said oxidizer nozzle centerline is inclined at an angle φ from a line perpendicular to said first wall;
wherein said oxidizer jet boundary intersects with a centerline of said fuel jet at a crossing distance x_{c}, measured from said oxidizer nozzle along said oxidizer nozzle centerline; and
means for maintaining said dilution ratio Δ between 2.5 and 4+(4+0.125*L²)/P^{0.5}, wherein L is measured in meters, P is the power of the furnace measured in megawatts, and the dilution ratio Δ is defined as Δ=0.119 (x_{c}/d_{O}) (cos 9.7°/cos (φ+9.7°)).

57. The furnace of claim 56, further comprising means for maintaining said dilution ratio Δ between 2.5 and 3+(1.3+0.042*L²)/P^{0.5}.

58. The furnace of claim 56, wherein L is at least 3 meters and at most 12 meters.
